(19) United States
(12) Patent Application Publication
(10) Pub. No.: US 2026/0233789 A1
(43) Pub. Date: Aug. 13, 2026

(54) COLLAPSIBLE AERODYNAMIC APPARATUS

(71) Applicant: International Truck Intellectual Property Company, LLC, Lisle, IL (US)

(72) Inventors: Saroj Kumar Singh, Dist- Rohtas Bihar (IN); Hugo del Rio Andre, Chicago, IL (US); Michael John Muff, Plainfield, IL (US)

(73) Assignee: International Truck Intellectual Property Company, LLC, Lisle, IL (US)

(21) Appl. No.: 19/154,094

(22) PCT Filed: Feb. 7, 2023
(86) PCT No.: PCT/US23/12477

§ 371 Date: Aug. 6, 2025

(51) Int. Cl. B62D 35/00

(52) U.S. Cl. CPC B62D 35/001

(57) ABSTRACT

The present disclosure relates to embodiments of aerodynamic apparatus and method for use on a tractor-trailer combination. The aerodynamic apparatus moves in different orientations in relation to the tractor-trailer combination. The aerodynamic apparatus includes a cab extender that moves between positions relative to the cab and trailer for reducing and expanding a gap between the cab and the trailer affecting the aerodynamic qualities of the tractor-trailer combination.

### TECHNICAL FIELD

The present disclosure relates to an aerodynamic apparatus and a method for improving aerodynamics and fuel efficiency of any type of vehicle, viz. a towing vehicle, configured for pulling or towing a trailer. Specifically, present disclosure relates to an add-on collapsible cab extender and method to move collapsible cab extender between positions to alternatively reduce and expand a gap between the cab and the trailer. The collapsible cab extender and method enable moving a cab extender between an unfolded or expanded position and a folded or reduced position in relation to the cab and the trailer,

### BACKGROUND

Increasing the aerodynamic performance of commercial vehicles, including fleet semitrucks is important for fuel efficiency, reducing harmful emissions and reducing overall fleet operating costs. Some approaches for increasing fuel efficiency specifically address the problem created by a gap between the cab and trailer and trailer edges. During travel, air leaving the rear edge of the cab hits the front edge and face of the trailer causing an increase in drag, which results in less efficient fuel usage and overall decreased performance. Efforts to improve aerodynamic performance include incorporating add-on aerodynamic devices including aero bumpers, chassis skirt panels, chassis modesty panels, air deflectors and cab-trailer gap extender devices.

For example, utilization of a cab extender effectively reduces the gap width between the cab and the trailer, thereby restricting airflow from entering the gap width and causing drag on the trailer. Addition of a cab extender to the cab directs airflow over and around the reduced gap diminishing drag and improving overall aerodynamics of the cab-trailer combination comprising a tractor having a cab and a trailer. Increasing length of cab extender between the cab and edges of the trailer further improves aerodynamic performance and fuel efficiency of the cab.

However, there are potential drawbacks to increasing length of cab extender. A cab extender length may reduce the swing angle between the cab and trailer affecting cab-trailer combination ability to reverse and to move in tight spaces. Access to areas behind the cab may be inhibited by cab extender length, reducing storage areas for trailer hoses, connections, frame steps, etc. Finally, if reverse towing of a trailer is needed, cab extender length may need to be reduced because cab extender length may increase air loads and pressure loads while reverse towing a trailer.

Therefore, a need exists for an improved collapsible aerodynamic apparatus and a method for moving a collapsible aerodynamic apparatus into various orientations for incorporation onto any type of vehicle configured for pulling or towing a trailer. Specifically, a need exists for an improved cab extender and method of moving a cab extender between various orientations including between an unfolded or extended position and a folded or reduced position in relation to the cab and trailer. The collapsible cab extender can be moved into a position that does not reduce tractor-trailer combination movement or reduce access behind the cab without requiring removal of the cab extender. It is contemplated the collapsible aerodynamic apparatus and a method for moving a collapsible aerodynamic apparatus of the present disclosure can be incorporated into any type of vehicle capable of pulling or towing a trailer.

### SUMMARY

One embodiment of a collapsible aerodynamic apparatus for improving aerodynamics and fuel efficiency of a towing vehicle, the apparatus comprising an extender panel configured for reducing and expanding a gap between a cab and a trailer of the vehicle and a bracket assembly for securing the extender panel to the cab, the bracket assembly configured for moving the extender panel between a first position and a second position.

### BRIEF DESCRIPTION OF THE DRAWINGS

FIG. 1 illustrates an example of a cab-trailer combination comprising a tractor and a trailer incorporating an aerodynamic apparatus in the form of a cab extender;

FIG. 2 illustrates a bracket assembly of the present disclosure with the cab extender in an unfolded or extended position;

FIG. 3 illustrates the bracket assembly of the present disclosure with the cab extender in a folded or reduced position;

FIG. 4 illustrates an arrangement of a plurality of bracket assemblies of the present disclosure with the cab extender in an unfolded or extended position.

FIG. 5 illustrates an arrangement of a plurality of bracket assemblies of the present disclosure with the cab extender in a folded or reduced position;

FIG. 6 illustrates a side view of a cab including the cab extender of the present disclosure in an unfolded or extended position;

FIG. 7 illustrates a back view of a cab incorporating the cab extender of the present disclosure in an unfolded or extended position;

FIG. 8 illustrates a side view of a cab incorporating the cab extender of the present disclosure in a folded or reduced position; and,

FIG. 9 illustrates a back view of a cab incorporating the cab extender of the present disclosure in a folded or reduced position.

### DETAILED DESCRIPTION

The present disclosure relates to embodiments of an add-on aerodynamic apparatus for use on any type of vehicle, viz. a towing vehicle, configured for pulling or towing a trailer, and a method for moving the add-on aerodynamic apparatus in relation to the cab and trailer of the vehicle. Specifically, the present disclosure relates to a cab extender that moves between positions including a first position reducing a gap between the cab and the trailer, and a second position expanding the gap between the cab and the trailer. The present disclosure further relates to a method for moving a cab extender between an unfolded or extended position reducing the gap for improved aerodynamic performance, and a folded or reduced position that reduces interference with movement of the cab-trailer combination and access to areas behind the cab.

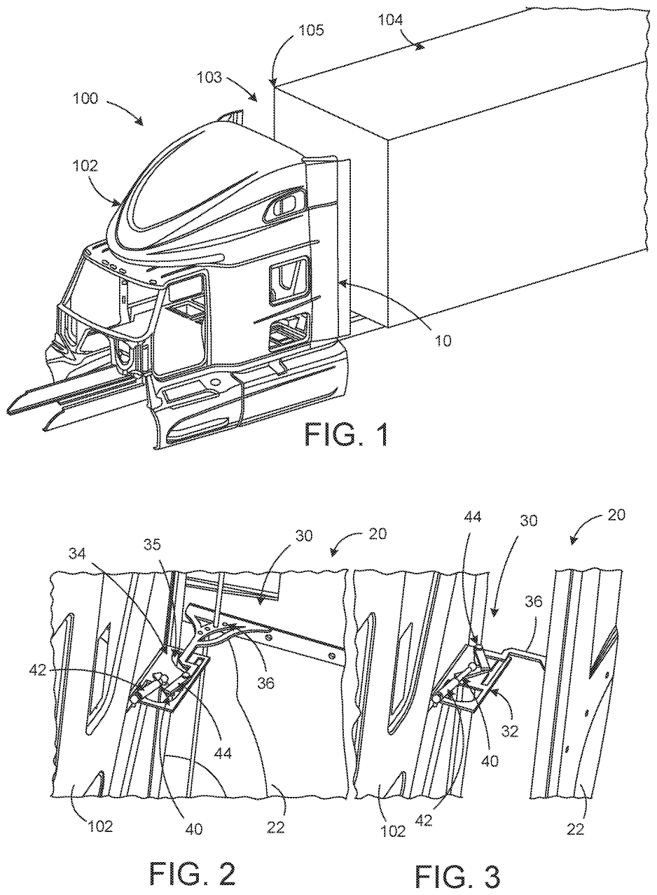

Cab extenders are add-on aerodynamic devices used between a cab and a trailer to direct airflow over and around the cab-trailer gap diminishing drag and improving overall aerodynamics and fuel efficiency of the cab-trailer combination. FIG. 1 represents a standard cab-trailer combination 100 having a cab 102 and a trailer 104. A cab extender 10 extends from the rear of the cab 102 and reduces the gap 103 between the cab 102 and the trailer 104 and/or trailer edges 105. Although only one side of the cab 102 is shown, in some embodiments, a cab extender is positioned on each side of the cab 102. Length of the cab extender 10 corresponds to reduction of the gap 103 and increased aerodynamic performance of the cab-trailer combination 100. However, while a cab extender 10 length improves aerodynamic performance and fuel efficiency of the cab-trailer combination 100, length of the cab extender 10 may interfere with movement of the cab-trailer combination 100 and limit access to areas behind the cab 102.

For example, cab extender 10 length may decrease swing angle between the cab 102 and the trailer 104. This may limit movement of the cab-trailer combination 100 when reversing the cab-trailer combination 100 in tight areas. Additionally, cab extender 10 length reduce access to connections and storage areas behind the cab 102. In a situation where reverse towing of a trailer 104 is needed, the cab extender 10 length may increase air loads and pressure loads and require reduction of cab extender 10 length when the cab-trailer combination 100 is in a reverse towing situation. The present add-on aerodynamic apparatus and method for moving the add-on aerodynamic apparatus avoids these inconveniences.

The present disclosure overcomes the above issues by incorporating a collapsible aerodynamic apparatus 20 disposed adjacent the tractor-trailer combination 100. The collapsible aerodynamic apparatus 20 includes an extender panel 22 configured for extending a length of a cab 102 of a cab-trailer combination 100. The extender panel 22 of the present disclosure is longer in length than a standard gap extender, thereby providing an advantage of reducing the gap 103 between the cab 102 and the trailer 104 and/or trailer edges 105, improving overall aerodynamic performance and fuel efficiency.

An advantage of the present disclosure is the extender panel 22 being moveable between positions relative to the cab 102 and trailer 104. For example, the extender panel 22 is moveable between a first position, wherein the extender panel 22 is aligned with the cab 102 and trailer 104 to effectively reduce the gap 103 between the cab 102 and trailer 104 to enhance aerodynamic performance of the tractor-trailer combination 100, and a second position, wherein the extender panel orients into a reduced position behind the cab, permitting access to areas behind the cab, and to avoiding removal of the extender panel 22. Specifically, in the first position, the extender panel 22 is unfolded or extended relative to the cab 102 and trailer 104, while in the second position, the extender panel 22 is folded or reduced relative to the cab 102 and trailer 104.

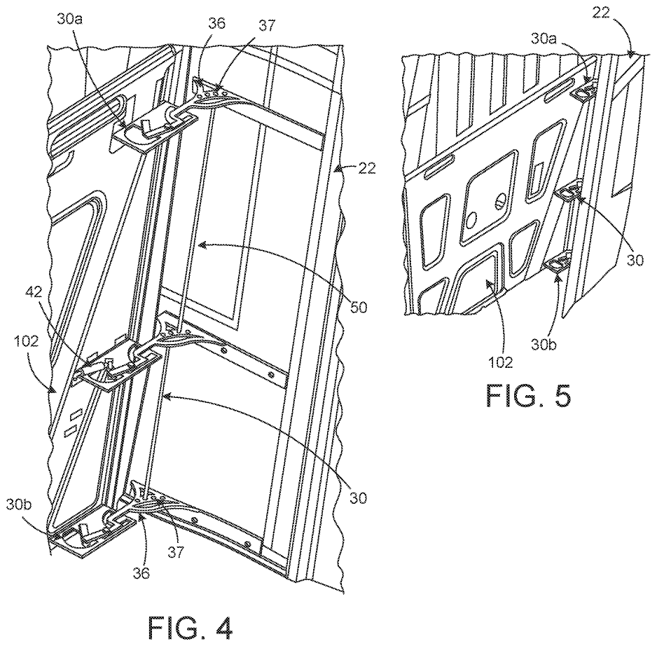

FIGS. 2 and 3 illustrate an embodiment of a bracket assembly 30 configured for attaching the extender panel 22 to the cab 102. The bracket assembly 30 is disposed between the extender panel 22 and the cab 102, and moves the extender panel 22 between the first position (FIG. 2) and the second position (FIG. 3). FIG. 4 illustrates an embodiment of an arrangement of a plurality of bracket assemblies 30, which secure to a rear of the cab 102 and extender panel 22, providing both movement and stability to the extender panel 22 so the extender panel 22 can be moved into separate orientations relative to the cab 102 and trailer 104.

The bracket assembly 30 comprises a bracket support 32, an actuator mechanism 40 within the bracket support 32, and an extension arm 36. The bracket support 32 secures to a rear of the cab 102 using fasteners. The extension arm 36 operatively connects to the actuator mechanism 40 at one end and extends outward from the bracket support 32 to connect to the extender panel 22 at an opposing end. The extension arm 36 fixes to the extender panel 22 enabling movement of the extender panel 22 upon activation of the actuator mechanism 40.

As shown in FIG. 2, the actuator mechanism 40 includes a piston 42, either electric or pneumatic. The piston 42 connects to an actuator 44, which moveably connects to the extension arm 36. Activation of the actuator mechanism 40, specifically activation of the piston 42 can be accomplished through an on/off switch (not shown) located anywhere in the tractor-trailer combination 100, or through a program on the tractor-trailer combination 100 resident on appropriate structure, such as a control module (not shown).

The bracket support 32 incorporates an interior guide channel 34. The interior guide channel 34 has a geometry configuration 35 providing a tracking pattern for movement of an actuator 44 and the associated extension arm 36 when the piston 42 is activated. The guided movement of the actuator 44 and extension arm 36 enables the extender panel 22 to change positions or orientation relative to the cab 102 and trailer 104.

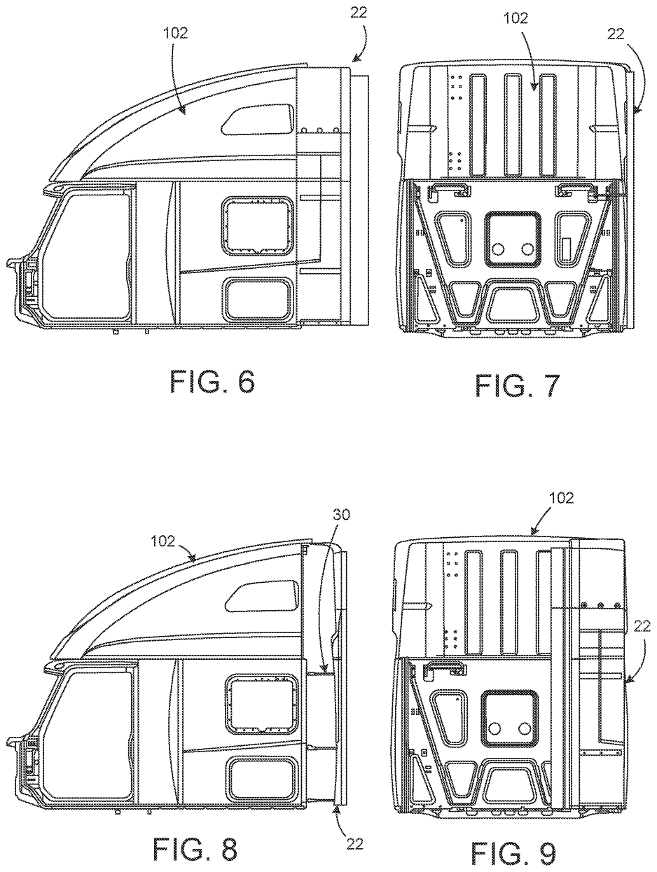

For example, activation of the actuator mechanism 40 enables movement of the extender panel 22 between a first position and a second position. Specifically, the extender panel 22 can be moved between a first unfolded or extended position (FIGS. 6 and 7) to a second folded or reduced position (FIGS. 8 and 9) in relation to the cab 102 and the trailer 104. To move the extender panel 22 from the first position to the second position, the activated piston 42 extends outward toward the extender panel 22, which moves the actuator arm 44 through the guide channel 34. This motion transfers to extension arm 36 and the connected extender panel 22, causing the extender panel 22 to rotate about 90 degrees thereby changing orientation from the first extended position to the second reduced position.

To move the extender panel 22 back from the second reduced position to the first extended position, the activated piston 42 pulls the actuator arm 44 inward in reverse direction through the guide channel 34. This motion transfers to the extension arm 36 and the connected extender panel 22, causing the extender panel 22 to rotate about 90 degrees from the second reduced position to the first extended position. The extender panel 22 is again in position to provide the improved aerodynamic qualities to the tractor-trailer combination 100 by reducing the gap 103 between the cab 102 and trailer 104.

In another embodiment shown in FIGS. 4 and 5, a plurality of bracket assemblies 30 can be secured to the rear of the cab 102 and the extender panel 22. Having more than one bracket assembly 30 provides additionally structural stability to the extender panel 22. In this arrangement, three bracket assemblies 30, 30a, 30b are shown, although it should be understood any number of bracket assemblies can be used. The three bracket assemblies 30, 30a, 30b are in alignment between the rear of the cab 102 and the extender panel 22.

Additionally, in this embodiment, only the center bracket assembly 30 is “active” because it includes the piston 42 of actuator mechanism 40 described above. The other two bracket assemblies, 30b, 30b, are “inactive” in that they do not have the piston 42 and cannot be independently activated for movement. Therefore, the other two bracket assemblies 30a, 30b rely on activation of the center bracket assembly 30 to operate moving the extender panel 22 between the first position (FIG. 4) and the second position (FIG. 5). It should be understood that any number of bracket assemblies, or all of the bracket assemblies can be active bracket assemblies.

To effect movement of all the three bracket assemblies 30, 30a, 30b, the bracket assemblies are aligned and connected by a vertical rod 50. As shown in FIG. 4, the extension arms 36 of each bracket assembly have a plurality of holes or openings 37 that receive the vertical rod 50. In this embodiment, the center bracket assembly 30 is the primary active bracket assembly, which guides movement of the other two bracket assemblies 30a, 30b. Activation of the piston 42 in the center bracket assembly 30 as previously described, moves the extender arm 36 of the center bracket assembly 30, which in turn rotates through the vertical rod 50 the extender arms 36 of the inactive bracket assemblies 30a, 30b. Thus, all three bracket assemblies 30, 30a, 30b work together to orient the extender panel 22 between the first and second positions. It should be understood that any option and configuration of active and inactive bracket assemblies can be implemented.

1. A collapsible aerodynamic apparatus for a tractor-trailer combination comprising a tractor having a cab with a rear surface and a trailer with a forward surface adjacent the rear surface of the cab and defining a gap between the rear surface of the cab and the front surface of the trailer, the collapsible aerodynamic apparatus comprising:
an extender panel moveable between a folded and unfolded position relative to the rear surface of the cab; and
a bracket support disposed in a fixed position to the rear surface of the cab;
the bracket support defining an interior guide channel of predetermined geometry;
a linkage comprising an extension arm portion and an actuator arm portion operatively interconnected;
the extension arm portion of the linkage connected to the extender panel and connected to the actuator arm;
the actuator arm having a portion disposed within the interior guide channel of the bracket support such that the interior guide channel of the bracket support defines the movement of pattern of the actuator arm relative to the support bracket;
a piston disposed on the support bracket and having a first portion connected to the support bracket in a fixed position, and a second portion connected to the actuator arm; and
the solenoid being moveable between extended and retracted positions such that movement of the solenoid to its extended position moves the actuator arm within the interior guide channel of the bracket support to effect movement of the extender panel to its folded position, and movement of the solenoid to its retracted position moves the actuator arm within the interior guide channel of the bracket support to effect movement of the extender panel to its unfolded position, such that the path of movement of the extender panel is defined by the path of the geometry of the interior guide channel of the bracket support.

2. The collapsible aerodynamic apparatus of claim 1, wherein the solenoid is remotely actuated between its extended and retracted position by a control module operatively connected with the solenoid wherein the control module is configured to actuate the solenoid based on predetermined operating conditions.

3. The collapsible aerodynamic apparatus of claim 1, wherein a plurality of bracket supports are provided in fixed position to the rear surface of the cab, and each of said plurality of bracket supports has a corresponding extension arm and actuator arm operative connected to the extender panel and the respective support bracket with the solenoid being disposed on only one of the plurality of support brackets.

4. The collapsible aerodynamic apparatus of claim 1, wherein the interior guide channel of the bracket defines a curvilinear geometry.

5. The collapsible aerodynamic apparatus of claim 4, wherein the curvilinear geometry of the interior guide channel comprises a straight portion and a curved portion.

6. (canceled)

7. (canceled)

8. (canceled)

9. (canceled)

10. (canceled)
